(19) United States
(12) Patent Application Publication
(10) Pub. No.: US 2020/0009590 A1
(43) Pub. Date: Jan. 9, 2020

(54) FLUID APPLICATOR

(71) Applicant: Jacek Pinski, La Canada, CA (US)

(72) Inventor: Jacek Pinski, La Canada, CA (US)

(21) Appl. No.: 16/457,587

(22) Filed: Jun. 28, 2019

Related U.S. Application Data
(60) Provisional application No. 62/695,295, filed on Jul. 9, 2018.

(51) Int. Cl. B05B 11/04; B65D 47/42; B65D 51/28; B05B 11/00

(52) U.S. Cl. CPC B05B 11/047; B05B 11/048; B05B 11/0072; B65D 51/2864; B65D 47/42

(57) ABSTRACT

The fluid applicators disclosed herein include an applicator cap and a squeezable bottle that can be releasably and fluidically coupled together. The applicator cap includes a tube, conduit, passageway, reservoir, chamber, cavity, lumen, and/or other features that direct fluid exiting the squeezable bottle through the applicator cap to exit the applicator cap via an opening, aperture, or hole that is disposed at a transverse angle, which can be perpendicular, relative to a longitudinal axis of the squeezable bottle. The fluid exiting via the opening, aperture, or hole is expelled onto and/or into an applicator surface or pad to be applied to the body of the user. The squeezable bottle can be used as a handle to effectively extend the reach of the user to enable the user to rub the applicator surface or pad, with expelled fluid, on the remote areas of a user's body.

### INCORPORATION BY REFERENCE TO ANY PRIORITY APPLICATIONS

This application claims the priority benefit of U.S. Application No. 62/695,295, filed Jul. 9, 2018, which is hereby incorporated by reference in its entirety herein.

Any and all applications for which a foreign or domestic priority claim is identified in the Application Data Sheet as filed with the present application are hereby incorporated by reference under 37 CFR 1.57.

### BACKGROUND

Fluids intended for use on the body, such as sunscreen lotion, are often stored in bottles. To apply a fluid, a user must expel the fluid from the bottle into the user's hand and spread the expelled fluid over the user's body with the user's hand. It can be difficult or impossible for a user to reach remote areas of the user's body, such as the user's back, to apply the fluid. It can also be inconvenient for a user's hands to be covered with the fluid. A user can ask for assistance from another individual in applying a fluid to remote areas of the user's body, but it can be inconvenient to find assistance and still result in the assisting individual's hands being covered with the fluid. Solutions that solve at least these problems are desirable.

### SUMMARY

Any feature, structure, or step disclosed herein can be replaced with or combined with any other feature, structure, or step disclosed herein, or omitted. Further, for purposes of summarizing the disclosure, certain aspects, advantages, and features of the inventions have been described herein. It is to be understood that not necessarily any or all such advantages are achieved in accordance with any particular embodiment of the inventions disclosed herein. No individual aspects of this disclosure are essential or indispensable.

The fluid applicators disclosed herein address at least the problems outlined above. The fluid applicators disclosed herein include an applicator cap that can fluidically couple to a squeezable bottle. The applicator cap includes a tube, conduit, passageway, reservoir, chamber, cavity, lumen, and/or other features that direct fluid exiting the squeezable bottle through the applicator cap to exit the applicator cap via an opening, aperture, or hole that is disposed at a transverse angle, which can be perpendicular, relative to a longitudinal axis of the squeezable bottle. The fluid exiting via the opening, aperture, or hole is expelled onto and/or into an applicator surface or pad to be applied to the body of the user. The squeezable bottle can be used as a handle to effectively extend the reach of the user to enable the user to rub the applicator surface or pad, with expelled fluid, on the remote areas of a user's body. For example, with the opening, aperture, or hole disposed at a perpendicular angle relative to the longitudinal axis of the squeezable bottle, the user can conveniently use the squeezable bottle has a handle to apply expelled fluid with the applicator surface or pad to the user's back. This can also advantageously enable a user to apply an expelled fluid with the applicator surface or pad without needing to contact the fluid with the user's hands. The applicator caps disclosed herein can be removed from one squeezable bottle and coupled to another squeezable bottle to extend the use of the applicator cap.

A fluid applicator is disclosed herein that can apply fluid to a body of a user. The fluid applicator can have a squeezable bottle that can be grasped by a user. The squeezable bottle can have a body extending between a first end and a second end along a longitudinal axis. The squeezable bottle can have a fixed length between the first end and the second end. The squeezable bottle can have an internal cavity. The internal cavity can extend from the first end to the second end over the fixed length of the squeezable bottle. The internal cavity can hold a fluid. The squeezable bottle can have a bottle outlet. The bottle outlet can be positioned on the first end of the squeezable bottle and can provide a conduit through which fluid exits the squeezable bottle. The fluid applicator can have an applicator cap. The applicator cap can couple to the first end of the squeezable bottle. The applicator cap can have a cap body having a first end and a second end. The first end of the cap body can have a periphery matching that of the first end of the body of the squeezable bottle. The periphery of the cap body between the first end and the second end may not decrease. The applicator cap can have an inner tube disposed within the cap body. The inner tube has a tube inlet that allows fluid to flow from the bottle outlet into the inner tube of the applicator cap when the applicator cap is coupled to the squeezable bottle. The inner tube can have a tube outlet that is disposed at a transverse angle to the longitudinal axis of the squeezable bottle. The tube outlet and tube inlet can be fluidically connected by the inner tube such that fluid exits from the internal cavity of the squeezable bottle through the tube outlet. The applicator cap can have an applicator surface disposed between the first end and the second end of the cap body. The applicator surface can be disposed proximate the tube outlet. The applicator surface can allow the user to apply fluid to a remote area of a body of the user by rubbing the applicator surface on the body of the user after fluid has exited the tube outlet while gripping the squeezable bottle around a portion of the squeezable body surrounding the internal cavity. The portion of the squeezable body surrounding the internal cavity can function as a handle.

In some aspects, the tube outlet is perpendicularly oriented relative to the longitudinal axis of the squeezable bottle.

In some aspects, the applicator surface is perpendicularly oriented relative to the longitudinal axis of the squeezable bottle.

In some aspects, the applicator surface has a circular periphery.

In some aspects, the applicator surface has an oval periphery.

In some aspects, the fluid applicator comprises a pad positioned on the applicator surface that can apply an expelled fluid to the body of the user.

In some aspects, the pad is made of foam.

In some aspects, the pad is made of sponge.

In some aspects, the pad comprises latex and/or polyurethane.

In some aspects, the applicator cap is coupled to the squeezable bottle with a threaded connection such that the applicator cap can be removed and placed on different bottles.

In some aspects, a valve is positioned at or upstream from the tube outlet such that less viscous fluids will not leak out of the outlet.

In some aspects, the inner tube comprises cross-sectional flow areas that vary in size to manipulate flow within the inner tube.

In some aspects, the first end of the cap body has a periphery that is the same or similar to the periphery of the first end of the squeezable bottle.

In some aspects, the fluid applicator is a unitary structure.

In some aspects, the second end of the cap body comprises a flat surface configured to support the fluid applicator to cause fluid stored in the internal cavity of the squeezable bottle to collect within the internal cavity proximate the first end of the squeezable bottle and the inner tube.

An applicator cap is disclosed herein that can apply fluid to a body of a user. The applicator cap can have a cap body that has a first end, a second end, and a periphery extending between the first end and the second end. The periphery of the cap body may not decrease. The applicator cap can have an inner tube disposed within the cap body. The inner tube can have a tube inlet that allows fluid to flow into the inner tube. The inner tube can have a tube outlet that is disposed perpendicularly relative to an axis of the tube inlet. The tube outlet and tube inlet can be fluidically connected by the inner tube to conduct fluid from the tube inlet to the tube outlet. The applicator cap can have an applicator surface disposed between the first end and the second end of the cap body. The applicator surface can be disposed proximate the tube outlet. The applicator surface can allow the user to apply fluid to a body of the user by rubbing the applicator surface on the body of the user after fluid has exited the tube outlet. The applicator cap can fluidically couple to a squeezable bottle that holds fluid such that the fluid can flow out of the squeezable bottle and through the applicator cap via the tube inlet, inner tube, and tube outlet to reach the applicator surface. The squeezable bottle can be configured to be grasped as a handle to effectively extend a reach of the user to rub the applicator surface on remote areas of the body of the user.

In some aspects, the applicator cap comprises a pad positioned on the applicator surface that is configured to apply an expelled fluid to the body of the user.

A fluid applicator is disclosed herein that can apply fluid to the body of a user. The fluid applicator can have a squeezable bottle that can be grasped by a user. The squeezable bottle can have a body extending between a first end and a second end along a longitudinal axis. The squeezable bottle can have a fixed length between the first end and the second end. The squeezable bottle can have an internal cavity. The internal cavity can extend from the first end to the second end over the fixed length of the squeezable bottle. The internal cavity can hold a fluid. The squeezable bottle can have a bottle outlet. The bottle outlet can be positioned on the first end of the squeezable bottle and can provide a conduit through which fluid exits the squeezable bottle. The squeezable bottle can have an applicator cap. The applicator cap can couple to the first end of the squeezable bottle. The applicator cap can have a cap body having a first end and a second end. The first end of the cap body can have a periphery matching that of the first end of the body of the squeezable bottle. The periphery of the cap body between the first end and the second end may not decrease. The applicator cap can have a reservoir disposed within the cap body. The reservoir can have a first opening to allow fluid to flow from the bottle outlet into the reservoir of the applicator cap when the applicator cap is coupled to the squeezable bottle. The reservoir can have a second opening that is disposed at a transverse angle to the longitudinal axis of the squeezable bottle. The second opening and first opening can be fluidically connected by the reservoir disposed within the cap body such that fluid exiting from the internal cavity of the squeezable bottle is directed into the reservoir before exiting through the second opening. The applicator cap can have a pad disposed between the first end and the second end of the cap body. The pad can be disposed proximate the second opening. The pad can enable the user to apply fluid to a remote area of the body of the user by rubbing the pad on the body of the user after fluid has exited the second opening while gripping the squeezable bottle around a portion of the squeezable body surrounding the internal cavity. The portion of the squeezable body surrounding the internal cavity can function as a handle.

In some aspects, the second end of the cap body has a flat surface configured to support the fluid applicator to cause fluid stored in the internal cavity of the squeezable bottle to collect within the internal cavity proximate the first end of the squeezable bottle and the reservoir.

In some aspects, the pad is curved around the longitudinal axis of the squeezable bottle.

### BRIEF DESCRIPTION OF THE DRAWINGS

Various embodiments are depicted in the accompanying drawings for illustrative purposes, and should in no way be interpreted as limiting the scope of the embodiments. Furthermore, various features of different disclosed embodiments can be combined to form additional embodiments, which are part of this disclosure.

FIG. 1 illustrates a fluid applicator in an assembled configuration.

FIG. 2 illustrates the fluid applicator of FIG. 1 with some features in a disassembled configuration.

FIG. 3 illustrates another fluid applicator in a disassembled configuration.

FIG. 4 illustrates the cap body of the fluid applicator of FIG. 3.

FIG. 5A illustrates another fluid applicator in an assembled configuration.

FIG. 5B illustrates a sectional view of the fluid applicator of FIG. 5A.

### DETAILED DESCRIPTION

Although certain embodiments and examples are described below, this disclosure extends beyond the specifically disclosed embodiments and/or uses and obvious modifications and equivalents thereof. Thus, it is intended that the scope of this disclosure should not be limited by any particular embodiments described below.

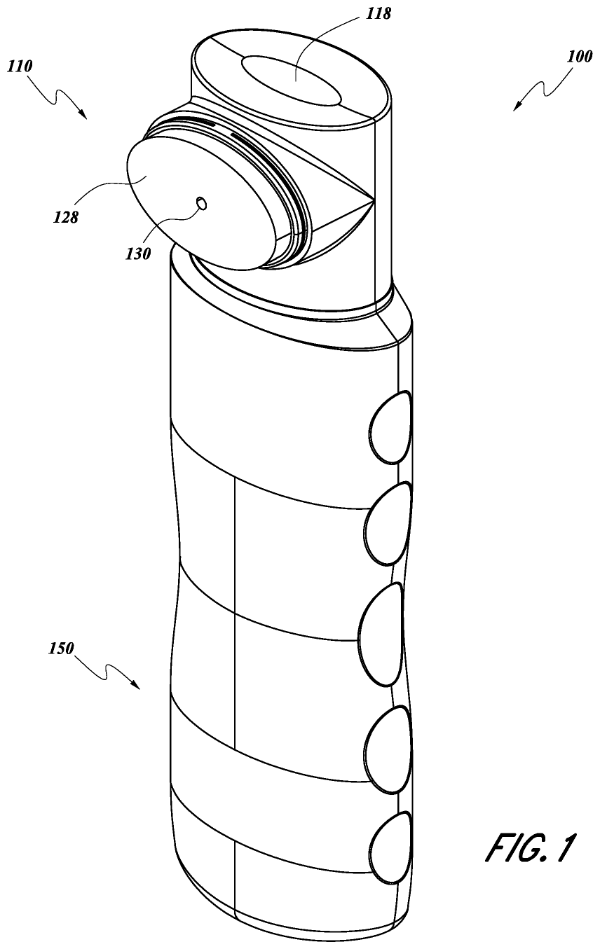

FIG. 1 illustrates a fluid applicator 100 in an assembled configuration. The fluid applicator 100 has an applicator cap 110. The applicator cap 110 includes a pad 128. The pad 128 has a hole 130.

The fluid applicator 100 includes a squeezable bottle 150. The applicator cap 110 is fluidically coupled to the squeezable bottle 150. The squeezable bottle 150 has an internal cavity that can store fluids for application to the skin of a user. The fluids can include lotions, creams, gels, jellies, balms, ointments, cleansers, salves, cosmetics, medicine, and/or any other fluid that is to be applied to the skin of a user. The pad 128 and hole 130 are perpendicularly oriented relative to the longitudinal axis of the squeezable bottle 150, but can include other transverse orientations.

In use, a user can squeeze the squeezable bottle 150 causing a fluid to flow from the internal cavity of the squeezable bottle 150 through the applicator cap 110 and out the hole 130. The expelled fluid can, upon exiting, be retained on and/or in the pad 128 for application to the skin of the user. Once fluid has exited the hole 130, a user can apply the expelled fluid by rubbing the pad 128 on the user's skin. This can advantageously enable a user to apply the expelled fluid to the skin of the user without requiring the user's hands to contact the expelled fluid, which can keep the user's hands clean of the expelled fluid. In use, a user can grasp the squeezable bottle 150 as a handle when applying the expelled fluid via rubbing of the pad 128 on the user's skin. This can advantageously extend the effective reach of the user such that the user can conveniently reach remote areas of the user's body, such as the user's back. The pad 128 and hole 130 are oriented perpendicularly to the longitudinal axis of the squeezable bottle 150, which can advantageously enable a user to comfortably reach the user's back.

When not in use, the fluid applicator 100 can be oriented such that the applicator cap 110 functions as a base contacting a support surface, enabling the fluid applicator 100 to stand upright with the applicator cap 110 positioned below the squeezable bottle 150. The applicator cap 110 has a second end 118. The second end 118 is flat or generally flat. This advantageously provides a firm base upon which the fluid applicator 100 can stand when not in use. This orientation can cause fluid within the internal cavity of the squeezable bottle 150 to flow into the applicator cap 110 and a portion of the internal cavity of the squeezable bottle 150 that is proximate the applicator cap 110. This advantageously positions the stored fluid in a position to readily and quickly exit the hole 130 upon a user squeezing the squeezable bottle 150.

The applicator cap 110 can optionally be removed from the squeezable bottle 150 and be coupled to a standard or conventional bottle for reuse. The applicator cap 110 can include a coupling feature, such as threads, which interface with the threads of standard or conventional bottles such that the applicator cap 110 can be used repeatedly. This can enable the applicator cap 110 to have an extended life of use.

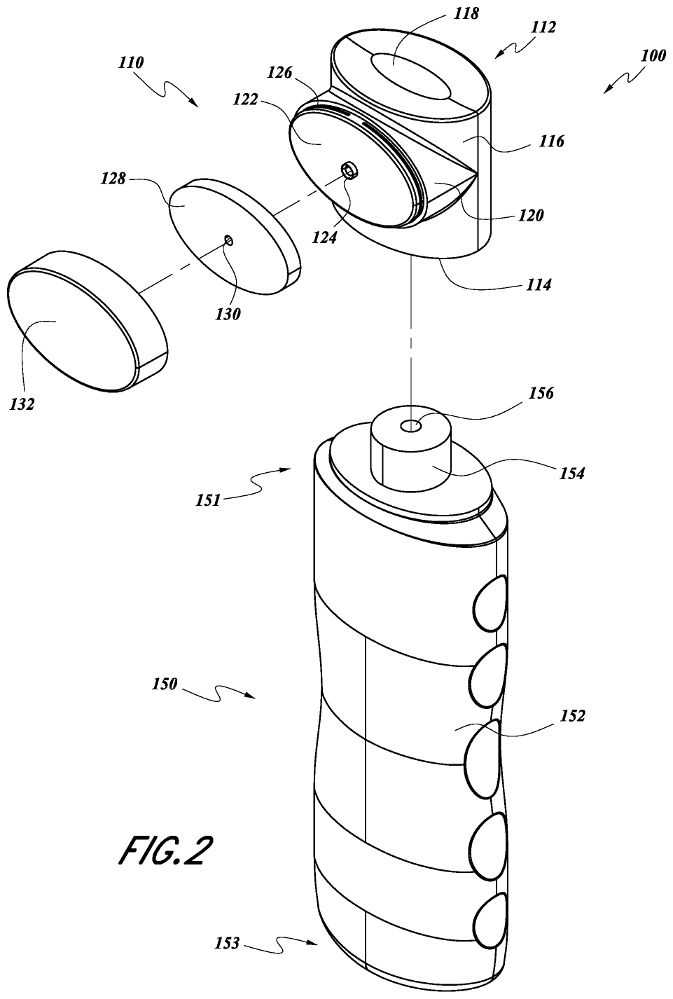

FIG. 2 illustrates the fluid applicator 100 with some features in a dissembled configuration. As described above, the fluid applicator 100 includes the applicator cap 110 that fluidically couples to the squeezable bottle 150. The applicator cap 110 couples to a first end 151 of the squeezable bottle 150. The applicator cap 110 has a cap body 112. The cap body 112 has a first end 114. The first end 114 has an oval shaped periphery. The first end 114 can be a variety of shapes, such as circular, polygonal, irregular, and/or other suitable shapes. The first end 114 has an opening enabling the applicator cap 110 to fluidically couple to the squeezable bottle 150. The first end 114 is positioned proximate the squeezable bottle 150 when the fluid applicator 100 is in the assembled configuration. The first end 114 has a periphery that matches, which can at least include size and shape, the periphery of the proximate portion of the squeezable bottle 150 when the fluid applicator 100 is in an assembled configuration. The first end 114 of the cap body 112 has a periphery that matches that of the first end 151 of a bottle body 152 of the squeezable bottle 150. Optionally, the first end 114 can have a periphery that is different, which can at least include size and shape, than the periphery of the proximate portion of the squeezable bottle 150 when the fluid applicator 100 is in the assembled configuration. For example, the first end 114 can have a periphery that is larger than the proximate portion of the squeezable bottle 150 such that the proximate portion of the squeezable bottle 150 is positioned within the periphery of the first end 114 when the fluid applicator 100 is assembled.

The cap body 112 has a second end 118. The second end 118 has an oval shaped periphery. The second end 118 can have a periphery that is a variety of shapes, such as circular, polygonal, irregular, and/or other suitable shapes. The second end 118 has a periphery that is the same as the first end 114. Optionally, the second end 118 can have a periphery that is different than the first end 114. The second end 118 is configured to provide a base upon which the fluid applicator 100 can stand when not in use such that stored fluid flows down within the internal cavity of the squeezable bottle 150 to position the fluid in the cap body 112 and towards the first end 151 of the squeezable bottle. As explained above, this advantageously positions the stored fluid in a position to readily and quickly exit for use upon a user squeezing the squeezable bottle 150. The second end 118 has a flat or generally flat surface. Optionally, the second end 118 has a flat or generally flat portion, that provides a stable base, but other portions that are not flat or generally flat.

A periphery 116 of the cap body 112 extends between the first end 114 and the second end 118. The size of the periphery 116 of the cap body 112 does not decrease between the first end 114 and the second end 118. This can advantageously decrease the likelihood that the cap body 112 will break during use, transportation, and/or storage. This can make the cap body 112 durable. For example, this decreases the likelihood that the cap body 112 will break when tossed into a bag or dropped onto the ground. As illustrated, a large portion of the periphery 116 is the same as the periphery of the first end 114 and the second end 118. The periphery 116 of the cap body 112 can change in size between the first end 114 and the second end 118. Optionally, the periphery 116 of the cap body 112 can indeed decrease in size between the first end 114 and the second end 118.

A transverse portion 120 extends from the periphery 116 of the cap body 112. The transverse portion 120 is disposed between the first end 114 and the second end 118 of the cap body 112. The transverse portion 120 extends from the periphery 116 at a transverse angle, which can be perpendicular, relative to the longitudinal axis of the cap body 112. The transverse portion 120 extends from the periphery at a transverse angle, which can be perpendicular, relative to the longitudinal axis of the squeezable bottle 150 when the applicator cap 110 is coupled to the squeezable bottle 150. The transverse portion 120 extends to have a periphery, for at least a portion, that has the same shape and/or size as the first end 114, the second end 118, and/or a portion of the periphery 116 of the cap body 112. Optionally, the transverse portion 120 can extend to have a periphery that is different than the first end 114, the second end 118, and/or a portion of the periphery 116 of the cap body 112. The transverse portion 120 has an opening that receives an applicator surface 122 described below. The opening is an oval. The opening can be can be a variety of shapes, such as circular, polygonal, irregular, and/or other suitable shapes. The transverse portion 120 can couple to the applicator surface 122 permanently with a weld, epoxy, adhesive, glue, press fit, snap fit, and/or other suitable connections. The transverse portion 120 can releasably couple to the applicator surface 122 with a snap fit, press fit, threaded connection, and/or other suitable manner. Optionally, the applicator surface 122 is a portion of the cap body 112, being a portion of a unitary or monolithic cap body 112.

The applicator cap 110 has an applicator surface 122. The applicator surface 122 is configured to couple within the opening of the transverse portion 120. In the assembled configuration, the applicator surface 122 is disposed between the first end 114 and the second end 118 of the cap body 112. The applicator surface 122 is an oval. The applicator surface 122 can be a variety of shapes, such as circular, polygonal, irregular, and/or other suitable shapes. The applicator surface 122 is flat or generally flat in order to facilitate spreading a fluid over the skin of a user and/or receive a pad 128 that applies fluid to the skin of the user. The applicator surface 122 is perpendicularly oriented, or other transverse orientations, relative to the longitudinal axis of the cap body 112, longitudinal axis of the squeezable bottle 150, longitudinal axis of the bottle outlet 154 (described below), and/or the axis of the conduit 156 (described below). Orienting the applicator surface 122 at a perpendicular angle relative to the longitudinal axis of the cap body 112 and/or squeezable bottle 150 can advantageously enable a user to easily and conveniently apply fluid to the remote areas of a user's body, such as the user's back. This can decrease the need for a user to strain to reach remote areas of the user's body.

The applicator surface 122 has an aperture 124. The aperture 124 is perpendicularly oriented, or other transverse orientations, relative to the longitudinal axis of the cap body 112, longitudinal axis of the squeezable bottle 150, longitudinal axis of the bottle outlet 154, and/or the axis of the conduit 156. Fluid exiting the squeezable bottle 150 and cap body 112 exit through the aperture 124 for application. Optionally, the aperture 124 or a location within the cap body 112 can have a valve that permits fluid to selectively exit through the aperture 124. The valve can be operated by pressure. The valve can be positioned at or upstream from the aperture 124 or tube outlet (sometimes these may be the same), which can prevent fluids, including less viscous fluids, from leaking out of the aperture 124 and/or tube outlet. The aperture 124 is surrounded by an annular wall that extends away from the applicator surface 122. The annular wall can direct fluid to flow from the aperture 124, through the hole 130, and into and/or beyond the pad 128 when the pad 128 is coupled to the applicator surface 122. The annular wall can help align the aperture 124 to the hole 130 of the pad 128. The applicator surface 122 can be made of the same material as the cap body 112 and/or other features of the fluid applicator 100. The applicator surface 122 can be made of a variety of materials that can include polymers (such as plastics), animal textiles (such as silk), plant textiles (such as cotton), mineral textiles (such as glass fiber), synthetic textiles (such as polyester), soft plastic film (such as polyethylene), foam, sponge, and/or other suitable materials, which can include soft and/or flexible materials. The applicator surface 122 can be latex and/or polyurethane. The applicator surface 122 can be foam or sponge.

The applicator surface 122 has a rim 126. The rim 126 interfaces with the cover cap 132, described below, to releasably couple to the cover cap 132. The rim 126 can be made of a variety of materials such as silicon, rubber, plastic, and/or any other polymer or material that is suitable to releasably retain the cover cap 132. The rim 126 and/or periphery of the cover cap 132 can deflect to releasably couple.

The cap body 112 can have tubing, conduits, passageways, reservoirs, chambers, cavities, lumens, and/or other features that enable fluid to be directed through the cap body 112 from the squeezable bottle 150 to the aperture 124.

The applicator cap 110 has a pad 128. The pad 128 couples to the applicator surface 122. The pad 128 can releasably or permanently couple to the pad 128, which can include using an adhesive, glue, epoxy, and/or another suitable manner of releasably or permanently coupling. Releasably coupling can be advantageous because a user can replace the pad 128 as needed due to wear, sanitation, multiple users, or for other reasons. Permanently coupling can be advantageous because a permanent connection can decrease the risk that the pad 128 will inadvertently decouple from the applicator surface 122. The pad 128 can be made of a variety of materials. The materials that make up the pad 128 can vary depending on the intended fluid to be applied using the pad 128. For example, the pad 128 can be made of an absorbent material that will soak up an expelled fluid for application to the skin of a user. In another example, the pad 128 can be made of a material that is not absorbent but is still soft, making it comfortable for a user to spread expelled fluid on the user's skin. The materials that make up the pad 128 can vary depending on the type of fluid that will be used. The pad 128 can be made of a variety of materials that can include at least polymers (such as plastics), animal textiles (such as silk), plant textiles (such as cotton), mineral textiles (such as glass fiber), synthetic textiles (such as polyester), soft plastic film (such as polyethylene), foam, sponge, and/or other suitable materials, which can include soft and/or flexible materials. The pad 128 can be latex and/or polyurethane. The pad 128 can be foam or sponge.

The pad 128 has a hole 130. The hole 130 extends through the entire pad 128. The hole 130 is a circle. The hole 130 can optionally be other suitable shapes, such as an oval, polygon, irregular shape, and/or other suitable shape. The hole 130 is aligned with the aperture 124 for use. The annular wall surrounding the aperture 124 can be positioned within the hole 130. The hole 130 enables fluid to flow out of the aperture 124, through the hole 130, and into and/or on the pad 128. The hole 130 has a consistent diameter. Optionally, the hole 130 can have a diameter or size that varies, having portions with one diameter/size and other portions with another diameter/size. The hole 130 is oriented at a perpendicular angle, or other transverse angles, relative to the longitudinal axis of the cap body 112, longitudinal axis of the squeezable bottle 150, longitudinal axis of the bottle outlet 154, and/or the axis of the conduit 156. The pad 128 can sometimes not have a hole 130, but instead, fluid exiting the aperture 124 is absorbed by the pad 128 for application to the skin of a user.

Optionally, no pad 128 is coupled to the applicator surface 122, and instead, expelled fluid is spread on the user's body directly with the applicator surface 122. With no pad 128, the annular wall around the aperture 124 can optionally not be included or can have a reduced or smoothed profile to ensure that the applicator surface 122 can comfortably glide over a user's skin.

The applicator cap 110 has a cover cap 132. The cover cap 132 is configured to cover and uncover the applicator surface 122 and/or pad 128 when the fluid applicator 100 is not in use. This can advantageously prevent the applicator surface 122 and/or pad 128 from becoming dirty during transportation/storage and/or can prevent the applicator surface 122, pad 128, and/or expelled fluid from inadvertently making contact with other objects and/or skin. The cover cap 132 has a periphery shape that is similar to the pad 128 and/or applicator surface 122. The cover cap 132 has an end surface that has a periphery shape that is similar to the pad 128 and/or applicator surface 122. A peripheral wall extends from the periphery of the end surface of the cover cap 132. The peripheral wall of the cover cap 132 interfaces with the rim 126 to releasably couple the cover cap 132 to the rim 126. The rim 126 and/or the peripheral wall of the cover cap 132 can deflect to facilitate the coupling. The peripheral wall has a length that is long enough to enable the end surface of the cover cap 132 to be offset from or proximate to the pad 128 and/or applicator surface 122 when the cover cap 132 is coupled to the rim 126. Optionally, the cover cap 132 can releasably couple with a portion of the transverse portion 120. Sometimes the cover cap 132 can releasably couple with the rim 126, applicator surface 122, and/or transverse portion 120 with a snap fit, press fit, threaded connection, or other suitable manner of releasably coupling.

The applicator cap 110 fluidically couples to a squeezable bottle 150. As explained above, the applicator cap 110 can be configured to fluidically couple to a standard connection of a bottle, such as with threads, such that the applicator cap 110 can be used repeatedly with a variety of bottles, which can extend the life of use of the applicator cap 110. The applicator cap 110 can releasably couple to the squeezable bottle 150 with a snap fit, press fit, threaded connection, or other suitable of releasably coupling. Optionally, the applicator cap 110 can be permanently coupled to the squeezable bottle 150.

The squeezable bottle 150 has a bottle body 152. The bottle body 152 extends between a first end 151 and a second end 153 along a longitudinal axis. The bottle body 152 has a fixed length between the first end 151 and the second end 153. The squeezable bottle 150 has a fixed length between the first end 151 and the second end 153. The bottle body 152 has an internal cavity that extends from the first end 151 to the second end 153 over the fixed length of the squeezable bottle 150 and/or the bottle body 152. The internal cavity of the squeezable bottle 150 can hold fluids, such as lotions, creams, gels, jellies, balms, ointments, cleansers, salves, cosmetics, medicine, and/or any other fluid that is to be applied to the skin of a user. Optionally, the squeezable bottle 150 can have an extendable and retractable portion that increases or decreases the length of the squeezable bottle 150. The bottle body 152 has a generally oval periphery that varies in size at different cross-sections of the bottle body 152. For example, a mid-portion of the bottle body 152 has a reduced size enabling a user to more easily grasp the bottle body 152. Optionally, the bottle body 152 has a periphery shape that is oval, polygonal, irregular, and/or any other suitable shape. The bottle body 152 has gripping portions along opposing peripheries of the bottle body 152 that enable a user to firmly grip the squeezable bottle 150. The bottle body 152 can optionally not have gripping portions. The bottle body 152 has a wall thickness that enables a user to squeeze the bottle body 152 such that the wall of the bottle body 152 deflects inward causing fluid to move toward the first end 151 and, ultimately, out the aperture 124 and/or opening 130. A user can advantageously use the bottle body 152 as a handle when applying expelled fluid using the applicator surface 122 and/or pad 128. This can effectively extend the reach of the user to comfortably reach remote areas of the user's body and reduce or eliminate the need for the user's hands to contact the expelled fluid for application.

As described above, the squeezable bottle 150 has a first end 151. The first end 151 is configured to couple to the applicator cap 110. The first end 151 has a bottle outlet 154 that includes a conduit 156. The bottle outlet 154 couples to the applicator cap 110. The bottle outlet 154 has a circular periphery. Optionally, the bottle outlet 154 can have a peripheral shape that is an oval, polygon, irregular shape, and/or other suitable shapes. The periphery of the bottle outlet 154, or a portion thereof, can be threaded to facilitate a threaded connection between the bottle outlet 154 and the applicator cap 110. Optionally, the periphery of the bottle outlet 154 can have ridges, recess, slots, and/or other features to facilitate coupling with the applicator cap 110. The periphery of the bottle outlet 154 is smaller than the periphery of the bottle body 152. The conduit 156 of the bottle outlet 154 enables fluid to flow out of the internal cavity of the squeezable bottle 150 and into the applicator cap 110. The conduit 156 is circular. The conduit 156 can optionally be oval, polygonal, irregular, and/or other suitable shapes.

As described above, the squeezable bottle 150 has a second end 153. The second end 153 is positioned opposite the first end 151. The second end 153 provides a base upon which the fluid applicator 100 can stand when not in use. The second end 153 has a flat or generally flat surface that provides a sturdy base. The second end 153 has an oval periphery. The second end 153 can have a periphery that is circular, polygonal, irregular, and/or other suitable shapes.

In use, a user can grasp the squeezable bottle 150 around a portion of the bottle body 152 and squeeze, deflecting in the wall of the bottle body 152 and causing fluid stored in the internal cavity to flow through the cap body 112 and out the aperture 124 and/or hole 130. A user can apply the expelled fluid to the body of the user by rubbing the applicator surface 122 and/or pad 128 on the skin of the user. The user can use the squeezable bottle 150 to reach remote areas of the user's body.

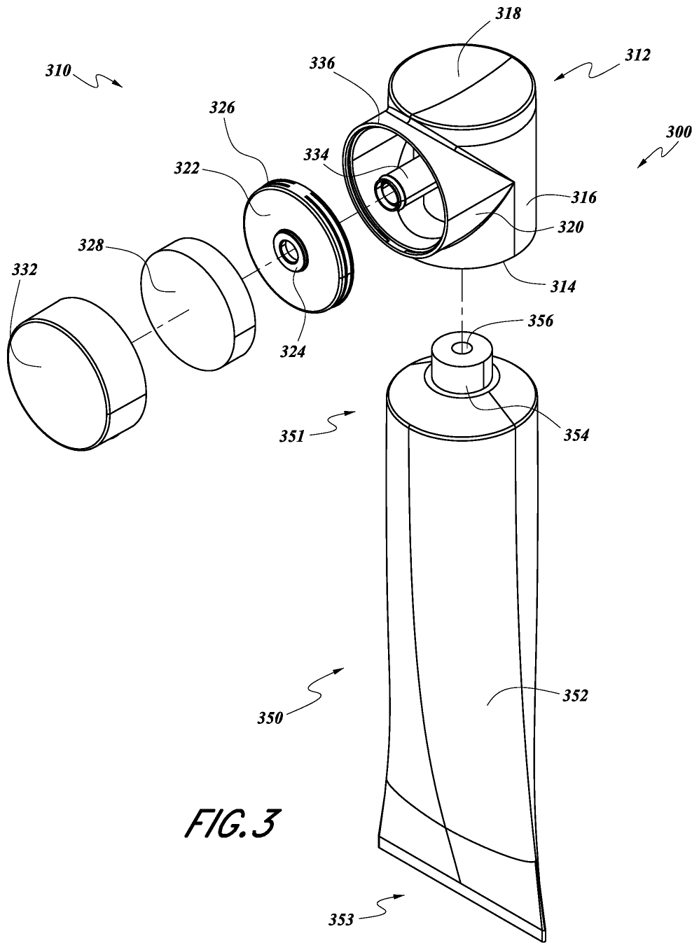

FIG. 3 illustrates another fluid applicator 300 in a disassembled configuration. The features of the fluid applicator 300 can resemble or be identical to the features of the fluid applicator 100 or other fluid applicators disclosed herein. Any component or step disclosed in any embodiment in this specification can be used in other embodiments.

The fluid applicator 300 includes an applicator cap 310 that fluidically couples to a squeezable bottle 350. The applicator cap 310 has a cap body 312. The cap body 312 has a first end 314. The first end 314 has a circular shape. The first end 314 can be a variety of shapes, such as oval, polygonal, irregular, and/or other suitable shapes. The first end 314 defines an opening enabling the applicator cap 310 to fluidically couple to the squeezable bottle 350. The first end 314 is positioned proximate the squeezable bottle 350 when the fluid applicator 300 is in an assembled configuration. The first end 314 has a periphery that matches, which can at least include size and shape, the periphery of the proximate portion of the squeezable bottle 350 when the fluid applicator 300 is in the assembled configuration. Optionally, the first end 314 can have a periphery that is different, which can at least include size and shape, than the periphery of the proximate portion of the squeezable bottle 350 when the fluid applicator 300 is in the assembled configuration.

The cap body 312 has a second end 318. The second end 318 has a circular shape. The second end 318 can be a variety of shapes, such as oval, polygonal, irregular, and/or other suitable shapes. The second end 318 has a periphery that is the same as the first end 314. Optionally, the second end 318 can have a periphery that is different than the first end 314. The second end 318 is configured to provide a base upon which the fluid applicator 300 can stand when not in use such that stored fluid flows down within the internal cavity of the squeezable bottle 350 to position the fluid in the cap body 312 and a portion of the internal cavity that is proximate the first end 351 of the squeezable bottle 350. As explained above, this advantageously positions the stored fluid in a position to readily and quickly exit for use upon a user squeezing the squeezable bottle 350. The second end 318 has a flat rim that provides a stable base upon which the fluid applicator 300 can stand. The second end 318 has an inwardly curved central portion that extends between the flat rim. The second end 318 can have a flat or generally flat surface.

A periphery 316 of the cap body 312 extends between the first end 314 and the second end 318. The size of the periphery 316 of the cap body 312 does not decrease between the first end 314 and the second end 318. This can advantageously decrease the likelihood that the cap body 312 will break during use, transportation, and/or storage. This can make the cap body 312 durable. For example, this decreases the likelihood that the cap body 312 will break when tossed into a bag or dropped onto the ground. As illustrated, a large portion of the periphery 316 is the same as the periphery of the first end 314 and the second end 318. The periphery 316 of the cap body 312 can change in size between the first end 314 and the second end 318. Optionally, the periphery 316 of the cap body 312 can decrease in size between the first end 314 and the second end 318.

A transverse portion 320 extends from the periphery 316 of the cap body 312. The transverse portion 320 is disposed between the first end 314 and the second end 318 of the cap body 312. The transverse portion 320 extends from the periphery 316 at a transverse angle, which can be perpendicular, relative to the longitudinal axis of the cap body 312 and/or the longitudinal axis of the squeezable bottle 350 when the applicator cap 310 is coupled to the squeezable bottle 350. The transverse portion 320 extends to have a periphery, for at least a portion, that has the same shape and/or size as the first end 314, the second end 318, and/or a portion of the periphery 316 of the cap body 312. The transverse portion 320 extends to have a circular periphery. Optionally, the transverse portion 320 can extend to have a periphery that is different than the first end 314, the second end 318, and/or portion of the periphery 316 of the cap body 312. Optionally, the transverse portion 320 extends to have a periphery that is an oval, polygon, irregular shape, and/or another suitable shape.

The transverse portion 320 has a transverse opening 336 that receives an applicator surface 322 described below. The transverse opening 336 is a circle. The transverse opening 336 can be can be a variety of shapes, such as an oval, polygon, irregular shape, and/or other suitable shapes. The transverse portion 320 can couple to the applicator surface 322 permanently with a weld, epoxy, adhesive, glue, press fit, and/or other suitable connection. The transverse portion 320 can releasably couple to the applicator surface 322 with a snap fit, press fit, threaded connection, and/or other suitable manner. Optionally, the applicator surface 322 is a portion of the cap body 312, being a portion of a unitary or monolithic cap body 312.

The cap body 312 has an inner tube 334 disposed within the cap body 312. The inner tube 334 directs fluid flow within the cap body 312. The inner tube 334 fluidically connects the conduit 356 and the aperture 324. The inner tube 334 is hollow. The inner tube 334 has a circular periphery. The inner tube 334 can have a periphery and/or cross-sectional flow area that varies in size to manipulate flow within the inner tube 334. Optionally, the inner tube 334 can have a periphery that is in the shape of an oval, polygon, and/or any other suitable shape.

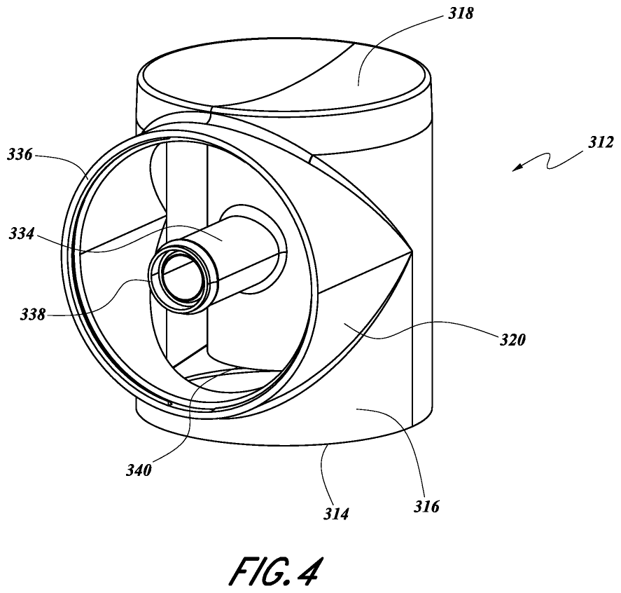

FIG. 4 illustrates an enlarged view of the cap body 312 which shows that the inner tube 334 has a tube inlet 340. The tube inlet 340 has a circular periphery. Optionally, the tube inlet 340 can have a different shaped periphery, which can include being an oval, polygon, irregular shape, and/or other shape. The tube inlet 340 fluidically couples to the bottle outlet 354. The tube inlet 340 can couple to the bottle outlet 354 with a snap fit, press fit, threaded connection, or other suitable manner of coupling. The tube inlet 340 can have internal threads that interface with the bottle outlet 354. The tube inlet 340 has an opening that receives the bottle outlet 354. Optionally, the tube inlet 340 can be received by the bottle outlet 354. The tube inlet 340 is fluidically connected with the conduit 356 such that the tube inlet 340 enables fluid to flow from the bottle outlet 354 through the tube inlet 340 and into the inner tube 334 when the fluid applicator 300 is assembled. The tube inlet 340 is positioned coaxially with the conduit 356 when the fluid applicator 300 is assembled. Optionally, the tube inlet 340 can be permanently coupled to the bottle outlet 354. As explained above, the applicator cap 310 can be configured to fluidically couple to different bottles with a standard connection, such as with threads, such that the applicator cap 310 can be used repeatedly with a variety of bottles, which can extend the life of use of the applicator cap 310.

The inner tube 334 has a tube outlet 338. The tube outlet 338 is smaller than the tube inlet 340. Optionally, the tube outlet 338 can be the same size or bigger than the tube outlet 338. The tube outlet 338 has a circular periphery. Optionally, the tube outlet 338 can have a different shaped periphery, which can include being an oval, polygon, irregular shape, and/or other shape. The tube outlet 338 is disposed at a transverse angle, which can be perpendicular, relative to the longitudinal axis of the squeezable bottle 350, bottle outlet 354, and/or conduit 356 when the fluid applicator 300 is assembled. The tube outlet 338 is disposed at a transverse angle, which can be perpendicular, relative to the axis of the tube inlet 340. The tube outlet 338 can have an end portion that interfaces with the applicator surface 322 and/or aperture 324. The tube outlet 338 can have an end portion that couples to the applicator surface 322 with a snap fit, press fit, and/or threaded connection. The tube outlet 322 can have an end portion that is inserted into the aperture 324.

The tube outlet 338 and the tube inlet 340 are fluidically connected by the inner tube 334 such that fluid exiting from the internal cavity of the squeezable bottle 350 can flow out the tube outlet 338.

The inner tube 334 can be coupled to the second end 318 of the cap body 312 to suspend the inner tube 334 within the cap body 312. Optionally, the inner tube 334 can be coupled to other portions of the cap body 312. The cap body 312 can be hollow, apart from housing the inner tube 334. Optionally, the cap body 312 is not hollow, apart from defining the inner tube 334.

Referring back to FIG. 3, the applicator cap 310 includes the applicator surface 322. The applicator surface 322 is configured to couple with the transverse portion 320 at the transverse opening 336. The applicator surface 322 can couple to the transverse portion 320 at the transverse opening 336 with a threaded connection, snap fit, press fit, or other suitable connection. Optionally, the applicator surface 322 is a portion of the cap body 312. The applicator surface 322 is disposed between the first end 314 and the second end 318 when the fluid applicator 300 is assembled. The applicator surface 322 is disposed proximate the tube outlet 338. The applicator surface 322 is perpendicularly oriented, or can include other transverse orientations, relative to the longitudinal axis of the cap body 312, longitudinal axis of the squeezable bottle 350, longitudinal axis of the bottle outlet 354, and/or the axis of the conduit 356. The applicator surface 322 has a circular shape. The applicator surface 322 can be a variety of shapes, such as an oval, polygon, irregular shape, and/or other suitable shapes. The applicator surface 322 is flat or generally flat in order to facilitate spreading a fluid over the skin of a user and/or receive a pad 328 that applies fluid on the skin of the user. Orienting the applicator surface 322 at a transverse angle, which can be perpendicular, relative to the longitudinal axis of the cap body 312 and/or squeezable bottle 350 can advantageously enable a user to easily and conveniently apply fluid to the remote areas of a user's body, such as the user's back. This can decrease the need for a user to strain to reach remote areas of the user's body.

The applicator surface 322 has an aperture 324. The aperture 324 is perpendicularly oriented, or other transverse orientations, relative to the longitudinal axis of the cap body 312, longitudinal axis of the squeezable bottle 350, longitudinal axis of the bottle outlet 354, and/or the axis of the conduit 356. Fluid exiting the squeezable bottle 350 flows through the inner tube 334 and out the aperture 324 for application. Optionally, the aperture 324 or the inner tube 334 can have a valve that permits fluid to selectively exit through the aperture 324. The valve can be operated by pressure. The valve can be positioned at or upstream from the aperture 324 and/or tube outlet such that less viscous fluids will not leak out of the tube outlet 338. The valve can be positioned at a position within the inner tube 334. The aperture 324 is surrounded by an annular wall that extends away from the applicator surface 322. The annular wall directs fluid to flow from the aperture 324 and into the pad 328 when the pad 328 is coupled to the applicator surface 322. The applicator surface 322 can be made of the same material as the cap body 312 and/or other features of the fluid applicator 300. The applicator surface 322 can be made of a variety of materials which can include polymers (such as plastics), animal textiles (such as silk), plant textiles (such as cotton), mineral textiles (such as glass fiber), synthetic textiles (such as polyester), soft plastic film (such as polyethylene), foam, sponge, and/or other suitable materials, which can include soft and/or flexible materials. The applicator surface 322 can be made of latex and/or polyurethane. The applicator surface 322 can be foam or sponge.

The applicator surface 322 has a rim 326. The rim 326 interfaces with the cover cap 332, described below, to releasably couple to the cover cap 332. The rim 326 can be made of a variety of materials such as silicon, rubber, plastic, and/or any other polymer or material that is suitable to releasably retain the cover cap 332.

The applicator cap 310 has a pad 328. The pad 328 couples to the applicator surface 322. The pad 328 can releasably or permanently couple to the pad 328, which can include using an adhesive, glue, epoxy, or other suitable manner of releasably or permanently coupling. Releasably coupling can be advantageous because a user can replace the pad 328 as needed due to wear, sanitation, multiple users, or for other reasons. Permanently coupling can be advantageous because a permanent connection can decrease the risk that the pad 328 will inadvertently decouple from the applicator surface 322. The pad 328 can be made of a variety of materials. The materials that make up the pad 328 can vary depending on the intended fluid to be applied using the pad 328. For example, the pad 328 can be made of an absorbent material that will soak up an expelled fluid for application to the skin of a user. The materials that make up the pad 328 can vary depending on the type of fluid that will be used. The pad 328 can be made of a variety of materials that can include polymers (such as plastics), animal textiles (such as silk), plant textiles (such as cotton), mineral textiles (such as glass fiber), synthetic textiles (such as polyester), soft plastic film (such as polyethylene), foam, sponge, and/or other suitable materials, which can include soft and/or flexible materials. The pad 328 can be latex and/or polyurethane. The pad 328 can be foam or sponge. The pad 328, as illustrated, does not have a hole like the hole 130 of the fluid applicator 100.

Optionally, no pad 328 is coupled to the applicator surface 322, and instead, expelled fluid is spread on the user's body directly with the applicator surface 322. With no pad 328, the annular wall around the aperture 324 can optionally not be included or can have a reduced or smoothed profile to ensure that the applicator surface 322 can comfortably glide over a user's skin.

The applicator cap 310 has a cover cap 332. The cover cap 332 is configured to cover and uncover the applicator surface 322 and/or pad 328 when the fluid applicator 300 is not in use. This can advantageously prevent the applicator surface 322 and/or pad 328 from becoming dirty during transportation/storage and/or can prevent the applicator surface 322, pad 328, and/or expelled fluid from inadvertently making contact with other objects and/or skin. The cover cap 332 has a periphery shape that is similar to the pad 328 and/or applicator surface 322. The cover cap 332 has an end surface that has a periphery shape that is similar to the pad 328 and/or applicator surface 322. A peripheral wall extends from the periphery of the end surface of the cover cap 332. The peripheral wall of the cover cap 332 interfaces with the rim 326 to releasably couple to the rim 326. The rim 326 and/peripheral wall of the cover cap 332 can deflect to facilitate the coupling. The peripheral wall has a length that is long enough to enable the end surface of the cover cap 332 to be offset from or proximate to the pad 328 and/or applicator surface 322 when the cover cap 332 is coupled to the rim 326. Sometimes the cover cap 332 can releasably couple with the applicator surface 322 or transverse portion 320 with a snap fit, press fit, threaded connection, or other suitable manner of releasably coupling.

The fluid applicator 300 has a squeezable bottle 350. The squeezable bottle 350 has a bottle body 352. The bottle body 352 extends between a first end 351 and a second end 353 along a longitudinal axis. The bottle body 352 has a fixed length between the first end 351 and the second end 353. The squeezable bottle 350 has a fixed length between the first end 351 and the second end 353. The bottle body 352 has an internal cavity that extends from the first end 351 to the second end 353 over the fixed length of the squeezable bottle 350 and/or the bottle body 352. The internal cavity of the squeezable bottle 350 can hold fluids, such as lotions, creams, gels, jellies, balms, ointments, cleansers, salves, cosmetics, medicine, and/or any other fluid that is to be applied to the skin of a user. Optionally, the squeezable bottle 350 can have an extendable and retractable portion that increases or decreases the length of the squeezable bottle 350. The bottle body 352 has a circular periphery proximate the first end 351 that tapers in the first end 351 to second end 353 direction, decreasing the cross-sectional size of the internal cavity of the bottle body 352, until the wall of the bottle body 352 is joined or flush at a longitudinal seam proximate the second end 353. Optionally, the bottle body 352 can have a periphery shape, proximate the first end 351, that is oval, polygonal, irregular, and/or any other suitable shape. The bottle body 352 has a wall thickness that enables a user to squeeze the bottle body 352 such that the wall of the bottle body 352 deflects inward causing fluid to move toward the first end 351 and out the aperture 324. A user can advantageously use the bottle body 352 as a handle when applying expelled fluid with the applicator surface 322 and/or pad 328. This can effectively extend the reach of the user to comfortably reach remote areas of the user's body and reduce or eliminate the need for the user's hands to contact the expelled fluid for application.

As described above, the squeezable bottle 350 has a first end 351. The first end 351 is configured to couple to the applicator cap 310. The first end 351 has a bottle outlet 354 that includes a conduit 356. The bottle outlet 354 couples to the tube inlet 340. The bottle outlet 354 has a circular periphery. Optionally, the bottle outlet 354 can have a peripheral shape that is an oval, polygon, irregular shape, and/or other suitable shapes. The periphery of the bottle outlet 354, or a portion thereof, can be threaded to facilitate a threaded connection between the bottle outlet 354 and the tube inlet 340. Optionally, the periphery of the bottle outlet 354 can have ridges, recess, slots, and/or other features to facilitate coupling with the tube inlet 340 or applicator cap 310. The periphery of the bottle outlet 354 is smaller than the periphery of the bottle body 352. The conduit 356 of the bottle outlet 354 enables fluid to flow out of the internal cavity of the squeezable bottle 350 and into the inner tube 334. The conduit 356 is circular. The conduit 356 can optionally be oval, polygonal, irregular, and/or other suitable shapes.

As described above, the squeezable bottle 350 has a second end 353. The second end 353 is positioned opposite the first end 351. The second end 353 joins the wall of the bottle body 352, sealing the internal cavity on the second end 353. In contrast to the second end 153, the second end 353, in the illustrated configuration, is not used as a base upon which the squeezable bottle 350 can stand. The second end 353 can have a variety of configurations, which can include having a rounded end, angular end, or other suitable configurations.

In use, a user can grasp the squeezable bottle 350 around a portion of the bottle body 352 and squeeze, causing fluid stored in the internal cavity to flow out the conduit 356, through the inner tube 334, and out the aperture 324. The pad 328 can absorb the expelled fluid. A user can apply the expelled fluid to the body of the user by rubbing the applicator surface 322 and/or pad 328 on the skin of the user. The user can use the squeezable bottle 350 as a handle to reach remote areas of the user's body.

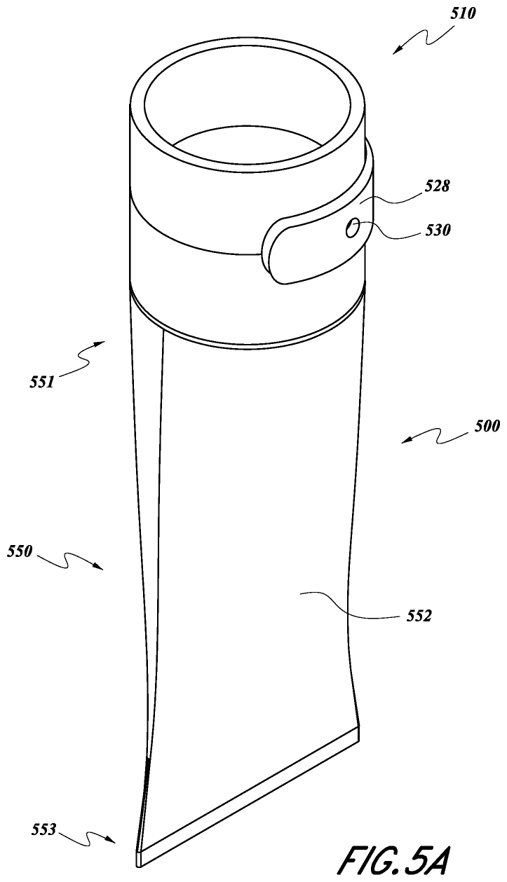

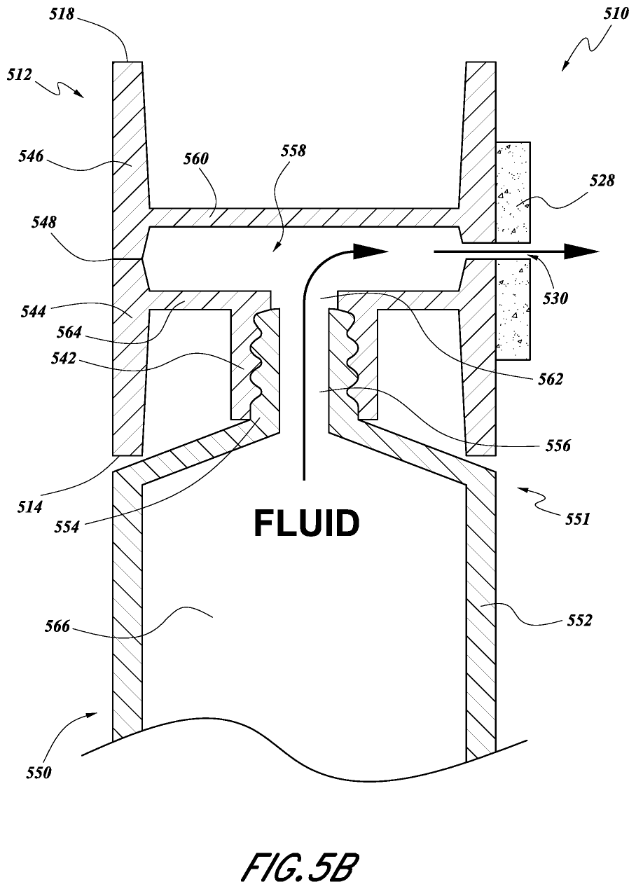

FIG. 5A illustrates another fluid applicator 500 in an assembled configuration. The features of the fluid applicator 500 can resemble or be identical to the features of the fluid applicator 100 and/or fluid applicator 300. Any component or step disclosed in any embodiment in this specification can be used in other embodiments.

The fluid applicator 500 has an applicator cap 510. The applicator cap 510 has a pad 528. The pad 528 surrounds a second opening 530. Unlike the pad 328 and pad 128, the pad 528 is not flat or generally flat, but instead, the pad 528 curves to the periphery of the applicator cap 510. The pad 528 is flush with the periphery of the applicator cap 510. The pad 528 has a longitudinal shape with curved end portions. The pad 528 can have a variety of shapes, which can include circular, polygonal, oval, irregular, and/or other shapes. The pad 528 can have the material and compositional qualities described in reference to the pad 328 and pad 128, which can include polymers (such as plastics), animal textiles (such as silk), plant textiles (such as cotton), mineral textiles (such as glass fiber), synthetic textiles (such as polyester), soft plastic film (such as polyethylene), foam, sponge, and/or other suitable materials, which can include soft and/or flexible materials. The pad 528 can be made of latex and/or polyurethane. The pad 528 can be foam or sponge.

The fluid applicator 500 has a squeezable bottle 550. The applicator cap 510 couples the first end 551 of the squeezable bottle 550. The squeezable bottle 550 is the same as the squeezable bottle 350, including the variations described in reference to the squeezable bottle 550. The squeezable bottle 550 has a first end 551, a second end 553, and a bottle body 552. The bottle body 552 extends between a first end 551 and a second end 153 along a longitudinal axis. The bottle body 552 has a fixed length between the first end 551 and the second end 553. The squeezable bottle 550 has a fixed length between the first end 551 and the second end 553. The bottle body 552 has an internal cavity that extends from the first end 551 to the second end 553 over the fixed length of the squeezable bottle 550 and/or the bottle body 552. The internal cavity of the squeezable bottle 550 can hold fluids, such as lotions, creams, gels, jellies, balms, ointments, cleansers, salves, cosmetics, medicine, and/or any other fluid that is to be applied to the skin of a user.

The pad 528 is positioned on the applicator cap 510 such that the pad 528 curves around the longitudinal axis of the applicator cap 510 and/or the squeezable bottle 350, when the fluid applicator 500 is assembled. The pad 528 is oriented such that the pad 528 is transverse, which can be perpendicular, to the longitudinal axis of the applicator cap 510 and/or the squeezable bottle 550, when the fluid applicator 500 is assembled. The second opening 530 is oriented in a transverse direction, which can be perpendicular, relative to the longitudinal axis of the cap body 512 and/or the squeezable bottle 528, when the fluid applicator 500 is assembled.

In use, a user can squeeze the squeezable bottle 550 causing a fluid to flow from the internal cavity of the squeezable bottle 550 through the applicator cap 510 and out the second opening 530. The expelled fluid can, upon exiting, be retained on and/or in the pad 528 for application to the skin of the user. Once fluid has exited the second opening 530, a user can apply the expelled fluid by rubbing the pad 528 on the user's skin. This can advantageously enable a user to apply the expelled fluid to the skin of the user without requiring the user's hands to contact the expelled fluid, which can keep the user's hands clean of the expelled fluid. In use, a user can grasp the squeezable bottle 550 as a handle when applying the expelled fluid to the user's skin via rubbing of the pad 528 on the user's skin. This can advantageously extend the effective reach of the user such that the user can conveniently reach remote areas of the user's body, such as the user's back.

When not in use, the fluid applicator 500 can be oriented such that the applicator cap 510 functions as a base contacting a support surface, enabling the fluid applicator 500 to stand upright with the applicator cap 510 positioned below the squeezable bottle 550. This orientation can cause fluid within the internal cavity of the squeezable bottle 550 to flow into the applicator cap 510 and a portion of the internal cavity that is proximate the first end 551. This advantageously positions the stored fluid in a position to readily and quickly exit the second opening 530 upon a user squeezing the squeezable bottle 550.

FIG. 5B illustrates a cross-sectional view of a portion of the fluid applicator 500 in an assembled configuration. Any component or step disclosed in any embodiment in this specification can be used in other embodiments.

The fluid applicator 500 has the applicator cap 510. The applicator cap 510 has a cap body 512. The cap body 512 has a first end 514. The first end 514 has a circular periphery. The first end 514 can have a periphery that is a variety of shapes, such as oval, polygonal, irregular, and/or other suitable shapes. The first end 514 defines an opening enabling the applicator cap 510 to couple to the squeezable bottle 550. The first end 514 is positioned proximate the squeezable bottle 550 when the fluid applicator 500 is in the assembled configuration. The first end 514 is offset from the squeezable bottle 550 in the assembled configuration. Optionally, the first end 514 can be flush with a portion of the squeezable bottle 550. The first end 514 has a periphery that matches, which can at least include size and shape, the periphery of a proximate portion of the squeezable bottle 550 when the fluid applicator 500 is assembled. The first end 514 has a periphery matching the first end 551 of the bottle body 552 of the squeezable bottle 550. The first end 514 of the cap body 512 has a periphery that matches that of the first end 551 of the bottle body 552 of the squeezable bottle 550. Optionally, the first end 514 can have a periphery that is different, which can at least include size and shape, than the periphery of the proximate portion of the squeezable bottle 550 when the fluid applicator 500 is in the assembled position.

The cap body 512 has a second end 518. The second end 518 has a circular periphery. The second end 518 can have a periphery that is a variety of shapes, such as oval, polygonal, irregular, and/or other suitable shapes. The second end 518 has a periphery that is the same as the first end 514. The second end 518 is a rim that has a flat or generally flat surface. The rim of the second end 518 surrounds a central surface 560 that is offset from the second end 518. The central surface 518 extends between the opposing portions of the second periphery 546. Optionally, the second end 518 can have a periphery that is different than the first end 514. The second end 518 provides a base upon which the fluid applicator 500 can stand when not in use such that stored fluid flows down within the internal cavity of the squeezable bottle 150 to position the fluid in the cap body 512 and a portion of the internal cavity that is proximate the applicator cap 510. As explained above, this advantageously positions the stored fluid in a position to readily and quickly exit for use upon a user squeezing the squeezable bottle 550.

A periphery of the cap body 512 extends between the first end 514 and the second end 518. The periphery has a first periphery 544 that is proximate the first end 514. The periphery has a second periphery 546 that is proximate the second end 518. The first periphery 544 and the second periphery 546 are joined at a joint 548. The first periphery 544 and the second periphery 546 are joined at the joint 548 by a weld, epoxy, adhesive, glue, and/or other similar manner of coupling. The first periphery 544 and the second periphery 546 can be portions of a monolithic or unitary periphery of the cap body 512. The first periphery 544 and/or the second periphery 546 have a circular periphery. Optionally, the first periphery 544 and/or second periphery 546 can have a different shaped periphery that can at least include an oval, polygon, irregular shape, and/or other suitable shapes. The periphery of the cap body 512, which includes the first periphery 544 and the second periphery 546, does not decrease between the first end 514 and the second end 518. This can advantageously decrease the likelihood that the cap body 512 will break during use, transportation, and/or storage. As illustrated, the periphery of the cap body 512, which includes the first periphery 544 and the second periphery 546, is the same as the periphery of the first end 514 and the second end 518. Optionally, the periphery of the cap body 512, which includes the first periphery 544 and the second periphery 546, can be larger or smaller than the periphery of the first end 514 and the second end 518.

The cap body 512 has a reservoir 558 disposed within the cap body 512. The reservoir 558 can store fluid proximate to the second opening 530. The reservoir 558 can be described as a chamber, cavity, lumen, and/or other similar terms. The reservoir 558 is defined by an inside surface of the periphery of the cap body 512 (includes the first periphery 544 and the second periphery 546), the central surface 460, and an engagement support 564. Optionally, the reservoir 558 can be defined by only some of the aforementioned features and/or other features/surfaces of the cap body 512. The reservoir 558 has a disk-like shape. Optionally, the reservoir 558 can have a variety of shapes.

The reservoir 558 has a first opening 562. The first opening 562 enables fluid to flow into the reservoir 558 from the conduit 556 of the bottle outlet 554 when the applicator cap 510 is coupled to the squeezable bottle 550. The first opening 562 is oriented coaxially with the conduit 556 and/or longitudinal axis of the squeezable bottle 450 when the fluid applicator 500 is assembled. The first opening 562 is an aperture extending through or defined by the engagement support 564. The first opening 562 has a circular periphery. Optionally, the first opening 562 can have a periphery of another shape, which can include an oval, polygon, irregular shape, and/or any other suitable shape.

The reservoir 558 has a second opening 530. The second opening 530 enables fluid to flow out the cap body 512. The second opening 530 is oriented transversely, which can be perpendicular, relative to the longitudinal axis of the cap body 512, the axis of the first opening 562, the longitudinal axis of the conduit 556, and/or the longitudinal axis of the squeezable bottle 550. The second opening 530 extends through the periphery of the cap body 512, which can include the first periphery 544 and the second periphery 546. As illustrated, the second opening 530 extends through the first periphery 544 and the second periphery 546. The second opening 530 has a circular periphery. Optionally, the second opening 530 can have a periphery of another shape, which can include an oval, polygon, irregular shape, and/or any other suitable shape. The second opening 530 can have a valve that enables fluid to exit the second opening 530, such that less viscous fluids will not leak out. The valve can be opened and closed with pressure. The second opening 530 and the first opening 562 are connected by the reservoir 558 disposed within the cap body 512 such that fluid exiting from the internal cavity of the squeezable bottle 550 is directed into the reservoir before exiting through the second opening 530.

The cap body 512 has a pad 528 positioned between the first end 514 and the second end 518. The pad 528 is positioned around the second opening 530. The pad 528 is positioned on a periphery of the cap body 512, which includes the first periphery 544 and the second periphery 546. The pad 528 curves to be flush with the circular periphery, which includes the first periphery 544 and the second periphery 546, of the cap body 512. The pad 528 is curved about the longitudinal axis of the cap body 512, the axis of the first opening 562, the longitudinal axis of the conduit 556, and/or the longitudinal axis of the squeezable bottle 550. The pad 528 is transversely oriented relative, which can be perpendicular, to the longitudinal axis of the cap body 512, the axis of the first opening 562, the longitudinal axis of the conduit 556, and/or the longitudinal axis of the squeezable bottle 550 when the fluid applicator 500 is assembled. The pad 528 can have at least the same configurations, features, materials, and/or compositional qualities described in reference to the pad 328, pad 128, applicator surface 122, and/or applicator surface 322. The pad 528 can be releasably coupled to the cap body 512, permanently coupled to cap body 512, or an integrated feature of the cap body 512. The pad 528 can be described as an applicator surface.

The cap body 512 has an engagement portion 542. The engagement portion 542 couples to the bottle outlet 554. The engagement portion 542 extends from the engagement support 564. The engagement support 564 is an annular structure that extends from the first periphery 544. The engagement support 564 radially surrounds the first opening 562, forming the periphery of the first opening 562. The engagement portion 542 extends from a portion of the engagement support 564 that is proximate the first opening 562. The engagement portion 542 is an annular structure that surrounds the first opening 562. The engagement portion 542 extends in a direction opposite the central surface 560. The engagement portion 542 is offset from the first periphery 544. The periphery of the engagement portion 542 is circular. The periphery of the engagement portion 542 can be a variety of shapes, such as an oval, polygon, irregular shape, and/or other suitable shapes. The engagement portion 542 couples to the bottle outlet 554 with a threaded connection. The engagement portion 542 has internal threads. The bottle outlet 554 has external threads. Optionally, the engagement portion 542 couples to the bottle outlet 554 with a snap fit, press fit, or other suitable manner of coupling. Optionally, the engagement portion 542 and the bottle outlet 554 are permanently coupled together. The engagement portion 542 can be configured to fluidically couple to different bottles with a standard connection, such as with threads, such that the applicator cap 510 can be used repeatedly with a variety of bottles, which can extend the life of use of the applicator cap 510.

The fluid applicator 500 has a squeezable bottle 550. As described above, the squeezable bottle 550 is the same as the squeezable bottle 350. The squeezable bottle 550 has a first end 551, a second end 553, and a bottle body 552. The bottle body 552 is hollow having an internal cavity 566 that can hold a fluid. The squeezable bottle 550 has a bottle outlet 554 positioned on the first end 551. The bottle outlet 554 couples to the engagement portion 542 of the cap body 512, coupling the applicator cap 510 to the squeezable bottle 550. The bottle outlet 554 has external threads that enable the bottle outlet 554 to screw into the engagement portion 542. The bottle outlet 554 has a conduit 556 through which fluid exits the squeezable bottle 550. The conduit 556 enables fluid to flow out of the internal cavity 566, through the first opening 562, into the reservoir 558, and ultimately, out the second opening 530 and into or on the pad 528. The conduit 556 has a circular periphery. The conduit 556 can have different shaped peripheries, which can include an oval, polygon, irregular shape, and/or another suitable shape.

In use, a user can grasp the squeezable bottle 550 around a portion of the bottle body 552 and squeeze to deflect in the wall forming the bottle body 552, causing fluid stored in the internal cavity 566 to exit through the conduit 556, flow through the first opening 562 and into the reservoir 558, and ultimately, out the second opening 530 and into or on the pad 528. The user can apply the expelled fluid to the body of the user by rubbing the pad 528 on the skin of the user. The user can use the squeezable bottle 550 as a handle to reach remote areas of the user's body. The perpendicular orientation of the pad 528 and/or second opening 530 relative to the longitudinal axis of the squeezable bottle 550 can enable a user to comfortably reach remote areas of the user's body.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The term “generally” as used herein represents a value, amount, or characteristic that predominantly includes or tends toward a particular value, amount, or characteristic. As an example, in certain embodiments, as the context may dictate, the term “generally perpendicular” can refer to something that departs from exactly parallel by less than or equal to 20 degrees.

Although certain embodiments and examples have been described herein, it will be understood by those skilled in the art that many aspects shown and described in the present disclosure may be differently combined and/or modified to form still further embodiments or acceptable examples. All such modifications and variations are intended to be included herein within the scope of this disclosure. A wide variety of designs and approaches are possible. No feature, structure, or step disclosed herein is essential or indispensable.

Some embodiments have been described in connection with the accompanying drawings. However, it should be understood that the figures are not drawn to scale. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

For purposes of this disclosure, certain aspects, advantages, and novel features are described herein. It is to be understood that not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Moreover, while illustrative embodiments have been described herein, the scope of any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to the examples described in the present specification or during the prosecution of the application, which examples are to be construed as non-exclusive. Further, the actions of the disclosed processes and methods may be modified in any manner, including by reordering actions and/or inserting additional actions and/or deleting actions. It is intended, therefore, that the specification and examples be considered as illustrative only, with a true scope and spirit being indicated by the claims and their full scope of equivalents.

Any methods disclosed herein need not be performed in the order recited. The methods disclosed herein include certain actions taken by a practitioner; however, they can also include any third-party instruction of those actions, either expressly or by implication.

What is claimed is:

1. A fluid applicator for applying fluid to a body of a user, the fluid applicator comprising:
a squeezable bottle that can be grasped by a user, and wherein the squeezable bottle comprises:
a body extending between a first end and a second along a longitudinal axis;
a fixed length between the first end and the second end;
an internal cavity, wherein the internal cavity extends from the first end to the second end over the fixed length of the squeezable bottle, and wherein the internal cavity is configured to hold a fluid; and
a bottle outlet, wherein the bottle outlet is positioned on the first end of the squeezable bottle and provides a conduit through which fluid exits the squeezable bottle;
an applicator cap, wherein the applicator cap is configured to couple to the first end of the squeezable bottle, the applicator cap comprising:
a cap body having a first end and a second end, the first end of the cap body having a periphery matching that of the first end of the body of the squeezable bottle, the periphery of the cap body between the first end and the second end thereof not decreasing;
an inner tube disposed within the cap body, wherein the inner tube has a tube inlet that allows fluid to flow from the bottle outlet into the inner tube of the applicator cap when the applicator cap is coupled to the squeezable bottle, wherein the inner tube has a tube outlet that is disposed at a transverse angle to the longitudinal axis of the squeezable bottle, and wherein the tube outlet and tube inlet are fluidically connected by the inner tube such that fluid exits from the internal cavity of the squeezable bottle through the tube outlet; and
an applicator surface disposed between the first end and the second end of the cap body, wherein the applicator surface is disposed proximate the tube outlet, and wherein the applicator surface is configured to allow the user to apply fluid to a remote area of a body of the user by rubbing the applicator surface on the body of the user after fluid has exited the tube outlet while gripping the squeezable bottle around a portion of the squeezable body surrounding the internal cavity, whereby the portion of the squeezable body surrounding the internal cavity functions as a handle.

2. The fluid applicator of claim 1, wherein the tube outlet is perpendicularly oriented relative to the longitudinal axis of the squeezable bottle.

3. The fluid applicator of claim 1, wherein the applicator surface is perpendicularly oriented relative to the longitudinal axis of the squeezable bottle.

4. The fluid applicator of claim 1, wherein the applicator surface has a circular periphery.

5. The fluid applicator of claim 1, wherein the applicator surface has an oval periphery.

6. The fluid applicator of claim 1, wherein the fluid applicator comprises a pad positioned on the applicator surface that is configured to apply an expelled fluid to the body of the user.

7. The fluid applicator of claim 6, wherein the pad is made of foam.

8. The fluid applicator of claim 6, wherein the pad is made of sponge.

9. The fluid applicator of claim 6, wherein the pad comprises latex and/or polyurethane.

10. The fluid applicator of claim 1, wherein the applicator cap is coupled to the squeezable bottle with a threaded connection such that the applicator cap can be removed and placed on different bottles.

11. The fluid applicator of claim 1, wherein a valve is positioned at or upstream from the tube outlet such that less viscous fluids will not leak out of the outlet.

12. The fluid applicator of claim 1, wherein the inner tube comprises cross-sectional flow areas that vary in size to manipulate flow within the inner tube.

13. The fluid applicator of claim 1, wherein the first end of the cap body has a periphery that is the same or similar to the periphery of the first end of the squeezable bottle.

14. The fluid applicator of claim 1, wherein the fluid applicator is a unitary structure.

15. The fluid applicator of claim 1, wherein the second end of the cap body comprises a flat surface configured to support the fluid applicator to cause fluid stored in the internal cavity of the squeezable bottle to collect within the internal cavity proximate the first end of the squeezable bottle and the inner tube.

16. An applicator cap for applying fluid to a body of a user, the applicator cap comprising:
a cap body having a first end, a second end, and a periphery extending between the first end and the second end, the periphery of the cap body not decreasing;
an inner tube disposed within the cap body, wherein the inner tube has a tube inlet that allows fluid to flow into the inner tube, wherein the inner tube has a tube outlet that is disposed perpendicularly relative to an axis of the tube inlet, and wherein the tube outlet and tube inlet are fluidically connected by the inner tube to conduct fluid from the tube inlet to the tube outlet;
an applicator surface disposed between the first end and the second end of the cap body, wherein the applicator surface is disposed proximate the tube outlet, and wherein the applicator surface is configured to allow the user to apply fluid to a body of the user by rubbing the applicator surface on the body of the user after fluid has exited the tube outlet; and
wherein the applicator cap is configured to fluidically couple to a squeezable bottle that holds fluid such that the fluid can flow out of the squeezable bottle and through the applicator cap via the tube inlet, inner tube, and tube outlet to reach the applicator surface and that is configured to be grasped as a handle to effectively extend a reach of the user to rub the applicator surface on remote areas of the body of the user.

17. The applicator cap of claim 16, wherein the applicator cap comprises a pad positioned on the applicator surface that is configured to apply an expelled fluid to the body of the user.

18. A fluid applicator for applying fluid to the body of a user, the fluid applicator comprising:
a squeezable bottle that is configured to be grasped by a user, and wherein the squeezable bottle comprises:
a body extending between a first end and a second along a longitudinal axis;
a fixed length between the first end and the second end;
an internal cavity, wherein the internal cavity extends from the first end to the second end over the fixed length of the squeezable bottle, and wherein the internal cavity is configured to hold a fluid; and
a bottle outlet, wherein the bottle outlet is positioned on the first end of the squeezable bottle and provides a conduit through which fluid exits the squeezable bottle;
an applicator cap, wherein the applicator cap is configured to couple to the first end of the squeezable bottle, the applicator cap comprising:
a cap body having a first end and a second end, the first end of the cap body having a periphery matching that of the first end of the body of the squeezable bottle, the periphery of the cap body between the first end and the second end thereof not decreasing;
a reservoir disposed within the cap body, wherein the reservoir has a first opening to allow fluid to flow from the bottle outlet into the reservoir of the applicator cap when the applicator cap is coupled to the squeezable bottle, wherein the reservoir has a second opening that is disposed at a transverse angle to the longitudinal axis of the squeezable bottle, and wherein the second opening and first opening are fluidically connected by the reservoir disposed within the cap body such that fluid exiting from the internal cavity of the squeezable bottle is directed into the reservoir before exiting through the second opening; and
a pad disposed between the first end and the second end of the cap body, wherein the pad is disposed proximate the second opening, and wherein the pad is configured to enable the user to apply fluid to a remote area of the body of the user by rubbing the pad on the body of the user after fluid has exited the second opening while gripping the squeezable bottle around a portion of the squeezable body surrounding the internal cavity, whereby the portion of the squeezable body surrounding the internal cavity functions as a handle.

19. The fluid applicator of claim 18, wherein the second end of the cap body comprises a flat surface configured to support the fluid applicator to cause fluid stored in the internal cavity of the squeezable bottle to collect within the internal cavity proximate the first end of the squeezable bottle and the reservoir.

20. The fluid applicator of claim 18, wherein the pad is curved around the longitudinal axis of the squeezable bottle.
